(19) United States
(12) Patent Application Publication
(10) Pub. No.: US 2026/0214725 A1
(43) Pub. Date: Jul. 23, 2026

(54) COMMUNICATION DEVICE, PROCESSING METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Kazuki YANAGISAWA, Nagano (JP)

(21) Appl. No.: 19/452,981

(22) Filed: Jan. 20, 2026

(30) Foreign Application Priority Data
Jan. 21, 2025 (JP) 2025-008293

(51) Int. Cl. H04W 76/10

(52) U.S. Cl. CPC H04W 76/10

(57) ABSTRACT

A communication device according to the present disclosure includes: an instruction receiving section that receives an input instructing the communication device to establish a wireless communication connection with an access point; and a wireless setting section that starts a DPP waiting process and a non-DPP waiting process in response to the reception of the input, and when the communication device receives the signal according to the wireless setting method defined in the DPP from another device, the wireless setting section stops the DPP waiting process and the non-DPP waiting process, and executes a DPP setting process.

The present application is based on, and claims priority from JP Application Serial Number 2025-008293, filed January 21, 2025, the disclosure of which is hereby incorporated by reference herein in its entirety.

### BACKGROUND

### Technical Field

The present disclosure relates to a communication device, a processing method, and a non-transitory computer-readable storage medium storing a program.

### Related Art

Various wireless setting methods for establishing a wireless communication connection between a communication device and an access point have been proposed. For example, JP-A-2011-193225 discloses AirStation One-Touch Secure System (AOSS) (registered trademark) and Wi-Fi Protected Setup-Push Button Configuration (WPS-PBC) as such wireless setting methods.

Incidentally, in recent years, Wi-Fi Alliance has developed a function called Wi-Fi Easy Connect (registered trademark) as a wireless setting method for establishing a wireless communication connection between a communication device and an access point. The function is a technology in which a device called a configurator provides access point information to a device called an enrollee in accordance with a Device Provisioning Protocol (DPP). Accordingly, the enrollee that has acquired the access point information can wirelessly connect to the access point.

In this way, there are various wireless setting methods that a user can select. Therefore, communication devices are required to support a plurality of types of wireless setting methods. Particularly, there is a demand for a communication device that can support a plurality of wireless setting methods, including the wireless setting method defined in DPP.

### SUMMARY

According to an aspect of the present disclosure, there is provided a communication device including: an instruction receiving section that receives an input instructing the communication device to establish a wireless communication connection with an access point; and a wireless setting section that starts a DPP waiting process and a non-DPP waiting process in response to the reception of the input, in which the DPP waiting process is a process of waiting for a signal from another device to establish the wireless communication connection between the communication device and the access point, the signal being a signal according to a wireless setting method defined in a Device Provisioning Protocol (DPP), the non-DPP waiting process is a process of waiting for a signal from the other device to establish the wireless communication connection between the communication device and the access point, the signal being a signal according to a predetermined wireless setting method other than the DPP, when the communication device receives the signal according to the wireless setting method defined in the DPP from the other device, the wireless setting section stops the DPP waiting process and the non-DPP waiting process, and executes a DPP setting process, and the DPP setting process is a predetermined setting process for establishing the wireless communication connection with the access point according to the wireless setting method defined in the DPP.

According to another aspect of the present disclosure, there is provided a processing method including: receiving, by a communication device, an input instructing the communication device to establish a wireless communication connection with an access point; and starting, by the communication device, a DPP waiting process and a non-DPP waiting process in response to the reception of the input, in which the DPP waiting process is a process of waiting for a signal from another device to establish the wireless communication connection between the communication device and the access point, the signal being a signal according to a wireless setting method defined in a Device Provisioning Protocol (DPP), the non-DPP waiting process is a process of waiting for a signal from the other device to establish the wireless communication connection between the communication device and the access point, the signal being a signal according to a predetermined wireless setting method other than the DPP, when the communication device receives the signal according to the wireless setting method defined in the DPP from the other device, the DPP waiting process and the non-DPP waiting process are stopped, and a DPP setting process is executed, and the DPP setting process is a predetermined setting process for establishing the wireless communication connection with the access point according to the wireless setting method defined in the DPP.

According to still another aspect of the present disclosure, there is provided a non-transitory computer-readable storage medium storing a program causing a computer of a communication device to execute: an instruction receiving step of receiving an input instructing the communication device to establish a wireless communication connection with an access point; and a wireless setting step of starting a DPP waiting process and a non-DPP waiting process in response to the reception of the input, in which the DPP waiting process is a process of waiting for a signal from another device to establish the wireless communication connection between the communication device and the access point, the signal being a signal according to a wireless setting method defined in a Device Provisioning Protocol (DPP), the non-DPP waiting process is a process of waiting for a signal from the other device to establish the wireless communication connection between the communication device and the access point, the signal being a signal according to a predetermined wireless setting method other than the DPP, in the wireless setting step, when the communication device receives the signal according to the wireless setting method defined in the DPP from the other device, the DPP waiting process and the non-DPP waiting process are stopped, and a DPP setting process is executed, and the DPP setting process is a predetermined setting process for establishing the wireless communication connection with the access point according to the wireless setting method defined in the DPP.

### BRIEF DESCRIPTION OF THE DRAWINGS

FIG. 1 is a schematic diagram showing a configuration example of an information processing system including a communication device.

FIG. 2 is a block diagram showing an example of a configuration of the communication device.

FIG. 3 is a sequence chart showing an example of a flow of wireless setting according to a first non-DPP method or a second non-DPP method.

FIG. 4 is a sequence chart showing an example of a flow of wireless setting according to a third non-DPP method.

FIG. 5 is a sequence chart showing an example of a flow of wireless setting according to a fourth non-DPP method.

FIG. 6 is a sequence chart showing an example of a flow of wireless setting according to a wireless setting method defined in DPP.

FIG. 7 is a block diagram showing an example of a configuration of a terminal device.

FIG. 8 is a block diagram showing an example of a configuration of an access point.

FIG. 9 is a flowchart showing a flow of operations of the communication device according to Embodiment 1.

FIG. 10A is a flowchart showing a flow of operations of the communication device according to Embodiment 2.

FIG. 10B is a flowchart showing a flow of operations of the communication device according to Embodiment 2.

FIG. 11 is a block diagram showing an example of a hardware configuration of a computer included in a communication device, a terminal device, or an access point.

### DESCRIPTION OF EMBODIMENTS

Embodiments and the like will be described below with reference to the drawings. For clarification of the description, the following description and drawings are appropriately omitted and simplified. In addition, in each drawing, the same elements are given the same reference numerals, and the redundant description thereof will be omitted as necessary. Furthermore, not all of the features or steps shown in any one drawing are necessarily required to describe an exemplary embodiment, and some features or steps may be omitted. Additionally, the order of steps depicted in any of the drawings may be changed as appropriate.

### Embodiment 1

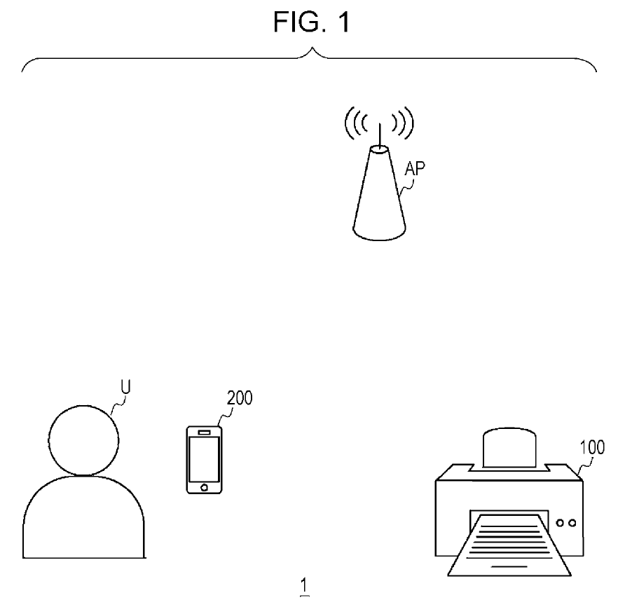

FIG. 1 is a schematic diagram showing a configuration example of an information processing system 1 including a communication device 100 according to an embodiment. As shown in FIG. 1, the information processing system 1 may further include a terminal device 200 and an access point AP. As will be described later, the communication device 100 is a device that supports a plurality of different wireless setting methods for establishing a wireless communication connection with the access point AP. The communication device 100 is a device that has not yet established a wireless communication connection with the access point AP, and establishes a wireless communication connection with the access point AP using any of the wireless setting methods selected by a user U. Specifically, the access point AP is, for example, a wireless local area network (LAN) router.

In the present embodiment, the communication device 100 is a printer that prints information on a medium such as paper, but the communication device 100 need not necessarily be a printer as long as it is a device that has a communication function.

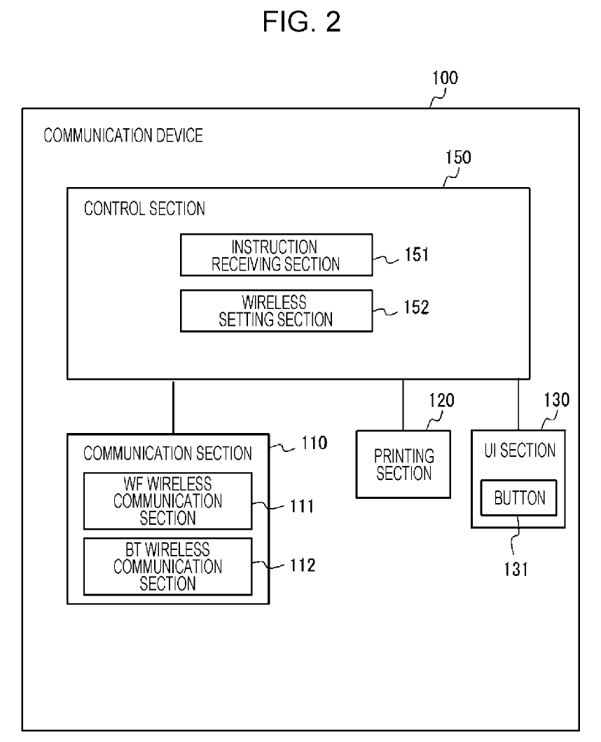

FIG. 2 is a block diagram showing an example of a configuration of the communication device 100. As shown in FIG. 2, the communication device 100 includes a communication section 110, a printing section 120, a user interface (UI) section 130, and a control section 150.

The communication section 110 is a hardware circuit that performs wireless communication with other devices according to a predetermined communication standard, and may include software such as firmware. The communication section 110 includes a WF wireless communication section 111 and a BT wireless communication section 112.

The WF wireless communication section 111 is a circuit that performs communication in accordance with a first wireless communication standard. That is, the WF wireless communication section 111 transmits information in accordance with the first wireless communication standard, or receives information in accordance with the first wireless communication standard. In the present embodiment, specifically, the WF wireless communication section 111 performs wireless communication in accordance with the Wi-Fi (registered trademark) standard.

The BT wireless communication section 112 is a circuit that performs communication in accordance with a second wireless communication standard. That is, the BT wireless communication section 112 transmits information in accordance with the second wireless communication standard, or receives information in accordance with the second wireless communication standard. In the present embodiment, the BT wireless communication section 112 performs Bluetooth communication, which is communication in accordance with the Bluetooth (registered trademark) standard. More specifically, in the present embodiment, the BT wireless communication section 112 performs wireless communication in accordance with the Bluetooth Low Energy (BLE) standard, which is a power-saving standard for Bluetooth.

The printing section 120 includes a print engine, which is a mechanical configuration that prints on a medium. In the present embodiment, the configuration of the printing section 120 will be described as being an ink jet printing configuration, but the printing section 120 may also include a print engine configured to print using coloring materials (toner) through an electrophotographic method. In addition, the medium is, for example, paper, but may also be cloth or the like.

In the present embodiment, the printing section 120 includes, as a print engine, for example, a print head that ejects coloring materials onto a medium. The print head uses a supplied coloring material (specifically, ink) to perform ink jet printing. In addition to the print head, the print engine may include a medium container for accommodating a medium, a transport mechanism for transporting the medium from the medium container to a position opposite the print head, a drive mechanism for driving a carriage including the print head, and the like. In this case, the printing section 120 prints information such as an image on a medium by ejecting coloring materials from a print head onto the medium transported by a transport mechanism.

The UI section 130 is a component that functions as a user interface. In the present embodiment, the UI section 130 includes a display. The UI section 130 may include an input device such as a button or a pointing device that receives input operations from the user U. The UI section 130 may be a touch panel in which an input device and a display are integrated. In the present embodiment, the UI section 130 as an input device has a button 131 for the user U to input a setting start instruction, which will be described later, into the communication device 100. The button 131 may be a physical button or a virtual button displayed on a touch panel.

The control section 150 controls the operation of the communication device 100. Particularly as functions for establishing a wireless communication connection between the access point AP external to the communication device 100 and the WF wireless communication section 111, the control section 150 includes an instruction receiving section 151 and a wireless setting section 152, as shown in FIG. 2.

The instruction receiving section 151 receives an input that instructs the communication device 100 to establish a wireless communication connection with the access point AP. Hereinafter, the instruction will also be referred to as a setting start instruction. The user U operates the above-described button 131 to input a setting start instruction to the communication device 100. Here, “operating the button 131” includes the operation of pressing the button 131 when the button 131 is a physical button. When the button 131 is operated, the instruction receiving section 151 receives an input of a setting start instruction.

The wireless setting section 152 executes a process of performing wireless settings in the communication device 100. That is, the wireless setting section 152 executes a process for establishing a wireless communication connection between the access point AP and the WF wireless communication section 111. Particularly, in the present embodiment, the wireless setting section 152 starts a DPP waiting process and a non-DPP waiting process in response to the instruction receiving section 151 receiving an input of a setting start instruction. Here, the DPP waiting process is a process of waiting for a signal from another device to establish a wireless communication connection between the communication device 100 and the access point AP, the signal being a signal according to the wireless setting method defined in DPP. Note that the DPP waiting process will be described in detail later. In this way, the communication device 100 supports the wireless setting method defined in the DPP. In addition, the non-DPP waiting process is a process of waiting for a signal from another device to establish a wireless communication connection between the communication device 100 and the access point AP, the signal being a signal according to a predetermined wireless setting method other than the DPP. Note that the non-DPP waiting process will be described in detail later. In the present embodiment, as will be described later, the communication device 100 supports four types of wireless setting methods, as wireless setting methods other than DPP, but it is sufficient that the communication device 100 supports at least one wireless setting method.

In addition, when the communication device 100 receives a signal according to the wireless setting method defined in DPP from another device, the wireless setting section 152 stops the DPP waiting process and the non-DPP waiting process, and executes the DPP setting process. That is, in this case, the wireless setting section 152 starts communication according to the DPP with the device that is the transmission source of the signal in order to perform wireless setting of the communication device 100. Here, the DPP setting process is a predetermined setting process for establishing a wireless communication connection with the access point AP, and particularly, is a setting process according to the wireless setting method defined in DPP. In contrast, when the communication device 100 receives a signal that is to be waited for in the non-DPP waiting process from another device, the wireless setting section 152 stops the DPP waiting process and the non-DPP waiting process, and executes a non-DPP setting process. That is, in this case, in order to perform wireless settings for the communication device 100, the wireless setting section 152 starts communication with the device that is the transmission source of the signal according to the wireless setting method corresponding to the signal. Here, the non-DPP setting process is a predetermined setting process for establishing a wireless communication connection with the access point AP, and particularly, is a setting process according to a predetermined wireless setting method other than DPP. Furthermore, the signals that are to be waited for in the non-DPP waiting process described above are signals according to a predetermined wireless setting method other than DPP, and in the present embodiment, the signals are signals according to any one of four types of wireless setting methods to be described below.

When the setting start instruction is received, the wireless setting section 152 may switch the screen of the UI section 130 (display) to a user interface screen for wireless setting (hereinafter referred to as a wireless setting screen). While the DPP waiting process, which will be described later, is being executed, an image of a two-dimensional code, which will be described later, is displayed on the wireless setting screen. Further, while the DPP setting process or the non-DPP setting process is being executed, an image for notifying the user U that the setting is in progress is displayed on the wireless setting screen. In this way, when an input of an setting start instruction is received, the wireless setting section 152 displays, on the UI section 130 (display) of the communication device 100, a screen that corresponds to the progress of establishing a wireless communication connection between the communication device 100 and the access point AP.

Next, the wireless setting methods that the communication device 100 can support in the present embodiment will be described. In the present embodiment, the communication device 100 supports five wireless setting methods (the wireless setting method defined in DPP and four other types of wireless setting methods). First, four types of wireless setting methods other than DPP (a first non-DPP method, a second non-DPP method, a third non-DPP method, and a fourth non-DPP method) will be described.

In the present embodiment, the first non-DPP method is specifically a wireless setting method defined in WPS-PBC. WPS-PBC is a wireless setting method that employs a push-button system and was defined in the Wi-Fi Alliance. In addition, in the present embodiment, the second non-DPP method is specifically a wireless setting method defined in AOSS. AOSS is a wireless setting method that employs a push-button system and was defined in Buffalo.

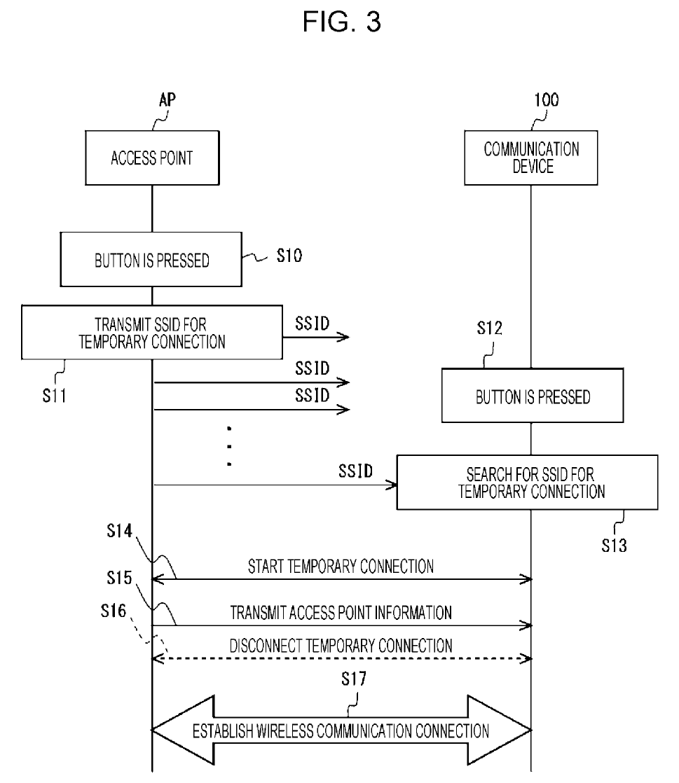

FIG. 3 is a sequence chart showing an example of a flow of wireless setting according to the first non-DPP method (WPS-PBC) or the second non-DPP method (AOSS). Hereinafter, the flow of wireless setting according to the first non-DPP method (WPS-PBC) or the second non-DPP method (AOSS) will be described with reference to FIG. 3.

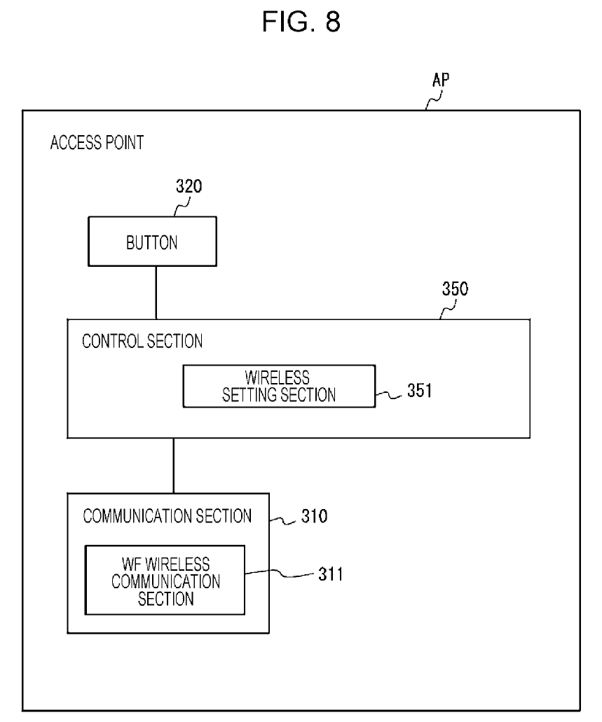

In step S10, the user U operates a button 320 (see FIG. 8) provided on the access point AP. This button 320 is a button for inputting an instruction to implement wireless settings according to WPS-PBC to the access point AP (hereinafter also referred to as a WPS button), or a button for inputting an instruction to implement wireless settings according to AOSS to the access point AP (hereinafter also referred to as an AOSS button). The button 320 may be a physical button or a virtual button displayed on a touch panel.

When the user U operates the button 320, in step S11, the access point AP starts transmitting a predetermined service set identifier (SSID) to establish a temporary connection with the communication device 100. Note that in the present disclosure, a temporary connection refers to a temporary wireless communication connection for wireless settings. When the button 320 is a WPS button, the access point AP transmits a predetermined SSID for WPS-PBC (hereinafter referred to as a WPS-dedicated SSID). In contrast, when the button 320 is an AOSS button, the access point AP transmits a predetermined SSID for AOSS (hereinafter referred to as an AOSS-dedicated SSID).

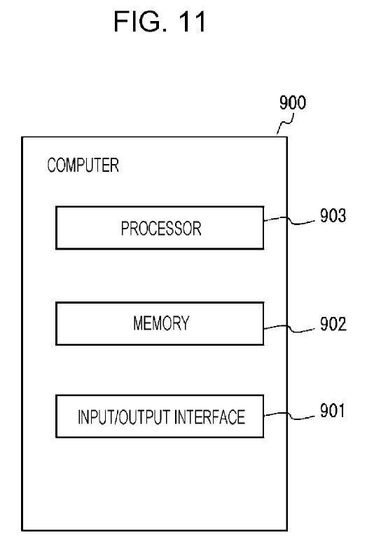

Next, in step S12, the user U operates the above-described button 131 of the communication device 100. Accordingly, the instruction receiving section 151 of the communication device 100 receives the setting start instruction, and the wireless setting section 152 starts the DPP waiting process and the non-DPP waiting process. In the present embodiment, the non-DPP waiting process includes a waiting process for WPS-PBC and a waiting process for AOSS. Therefore, in step S13, the wireless setting section 152 of the communication device 100 searches for (scans) a WPS-dedicated SSID using the WF wireless communication section 111 as a waiting process for WPS-PBC. Similarly, the wireless setting section 152 searches for (scans) an AOSS-dedicated SSID using the WF wireless communication section 111 as a waiting process for AOSS. The communication device 100 has previously specified the WPS-dedicated SSID and the AOSS-dedicated SSID. For example, a WPS-dedicated SSID and an AOSS-dedicated SSID are stored in advance in a storage device such as a memory 902 (see FIG. 11) of the communication device 100, and the wireless setting section 152 checks whether these SSIDs are being transmitted. In the sequence chart shown in FIG. 3, the wireless setting section 152 discovers (receives) the WPS-dedicated SSID or AOSS-dedicated SSID transmitted from the access point AP. Thus, in the present embodiment, the non-DPP waiting process includes a process of waiting for a signal (a Wi-Fi signal including a WPS-dedicated SSID) according to WPS-PBC from the access point AP. The non-DPP waiting process also includes a process of waiting for a signal according to AOSS from the access point AP (a Wi-Fi signal including an AOSS-dedicated SSID).

Thereafter, in step S14, the wireless setting section 152 of the communication device 100 uses the WF wireless communication section 111 to establish a temporary connection with the access point AP. That is, the communication device 100 and the access point AP start a temporary wireless communication connection in accordance with a Wi-Fi standard. Specifically, when the WPS-dedicated SSID is received, the wireless setting section 152 requests a temporary connection to the access point AP using the SSID and a password specified in advance for WPS. Similarly, when the AOSS-dedicated SSID is received, the wireless setting section 152 requests a temporary connection to the access point AP using the SSID and a password specified in advance for AOSS. For example, a password for WPS and a password for AOSS are stored in advance in a storage device such as the memory 902 (see FIG. 11) of the communication device 100, and the wireless setting section 152 uses either of these together with the SSID to request a temporary connection to the access point AP.

Next, in step S15, the access point AP transmits access point information about the network provided by the access point AP to the communication device 100 via a communication path of the temporary connection. In the present disclosure, the access point information is any information required to establish a wireless communication connection with an access point AP. When the access point AP transmits the access point information, the wireless setting section 152 acquires the access point information. Here, the provided access point information includes an SSID and a password, for example. Note that this SSID and password are different from the SSID and the password used for the temporary connection. When the access point information is provided to the communication device 100, in step S16, the wireless setting section 152 disconnects the temporary connection with the access point AP. Then, in step S17, the wireless setting section 152 of the communication device 100 uses the access point information acquired from the access point AP to establish a wireless connection (a wireless communication connection in accordance with the Wi-Fi standard) between the access point AP and the communication device 100 (the WF wireless communication section 111). In other words, in step S17, the communication device 100 uses the access point information to join a wireless LAN provided by the access point AP. Note that the series of processes from step S14 to step S17 is an example of a non-DPP setting process according to WPS-PBC or an example of a non-DPP setting process according to AOSS.

Next, the third non-DPP method and the fourth non-DPP method will be described. These wireless setting methods are methods for performing wireless settings of the communication device 100 using the terminal device 200 on which a setting application (application software) provided by the vendor of the communication device 100 is installed, for example. This setting application corresponds to a setting assistance section 251, which will be described later. The terminal device 200 is a device that has the access point information. The terminal device 200 may be a terminal that has already established a wireless communication connection with the access point AP, that is, a terminal that has already joined a wireless LAN provided by the access point AP. In the third non-DPP method and the fourth non-DPP method, access point information included in the terminal device 200 is transmitted to the communication device 100, and the communication device 100 establishes a wireless communication connection with the access point AP using the received access point information. Hereinafter, the third non-DPP method will also be referred to as Wi-Fi Auto Connect (WAC). Also, the fourth non-DPP method will be referred to as BLE-WAC.

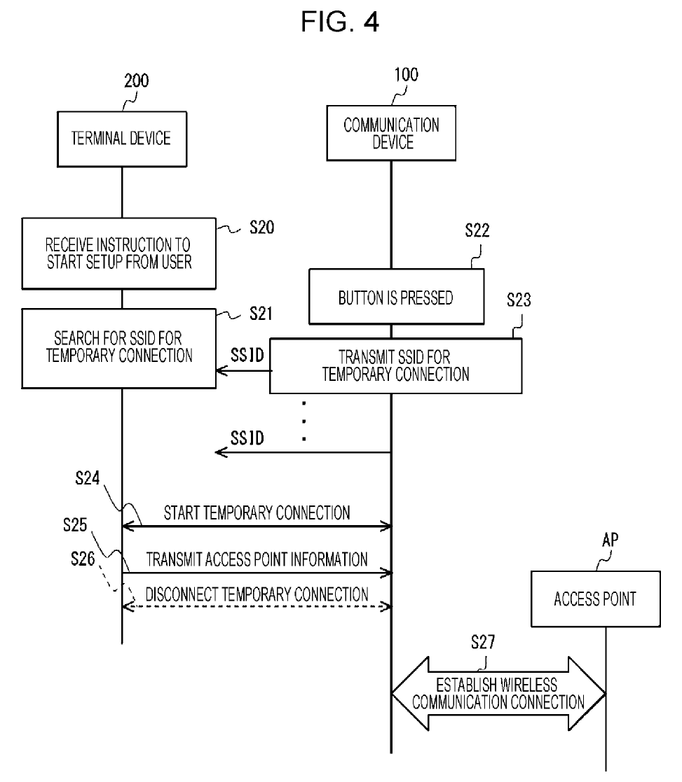

FIG. 4 is a sequence chart showing an example of a flow of wireless setting according to the third non-DPP method (WAC). Hereinafter, the flow of wireless setting according to the third non-DPP method (WAC) will be described with reference to FIG. 4. In FIG. 4, the terminal device 200 is, for example, a personal computer, but is not limited thereto.

In step S20, the user U inputs an instruction to the terminal device 200 (more specifically, the setting application of the terminal device 200) to start setup according to WAC. That is, the user U inputs an instruction to implement wireless setting according to the WAC. Accordingly, the setting application receives an instruction to start setup.

When an instruction to start setup according to the WAC is received, in step S21, the setting application starts searching for (scanning) an SSID for the WAC (hereinafter referred to as a WAC-dedicated SSID) using a WF wireless communication section 211, which will be described later. The WAC-dedicated SSID is an SSID transmitted from the communication device 100 in order to establish a temporary connection between the terminal device 200 and the communication device 100.

Next, in step S22, the user U operates the above-described button 131 of the communication device 100. Accordingly, the instruction receiving section 151 of the communication device 100 receives the setting start instruction, and the wireless setting section 152 starts the DPP waiting process and the non-DPP waiting process. In the present embodiment, the non-DPP waiting process includes a waiting process for the WAC. Therefore, in step S23, the wireless setting section 152 of the communication device 100 transmits a WAC-dedicated SSID for a temporary connection using the WF wireless communication section 111 as a waiting process for the WAC. More specifically, in the present embodiment, the wireless setting section 152 generates a WAC-dedicated SSID and a password according to predetermined rules, and activates Wi-Fi Direct (registered trademark) associated with the SSID and the password. That is, the wireless setting section 152 activates the software access point and transmits the WAC-dedicated SSID, which is the SSID of the software access point. The setting application of the terminal device 200 can generate the WAC-dedicated SSID and the password generated by the communication device 100 by using the predetermined rules described above. In this way, the terminal device 200 specifies the WAC-dedicated SSID and the password in advance. Therefore, in the sequence chart shown in FIG. 4, a setting application of the terminal device 200 discovers (receives) the WPS-dedicated SSID transmitted from the communication device 100. The communication device 100 and the terminal device 200 may use a fixed SSID and a fixed password as the WAC-dedicated SSID and the corresponding password, instead of generating the SSID and the password based on a predetermined rule. In this case, for example, a WAC-dedicated SSID is stored in advance in a storage device such as the memory 902 (see FIG. 11) of the terminal device 200, and the setting application checks whether the SSID is being transmitted.

In step S24, the setting application of the terminal device 200 that has received the WAC-dedicated SSID uses the WF wireless communication section 211 (described later) of the terminal device 200 to transmit a signal requesting a temporary connection (hereinafter also referred to as a WAC request signal) to the communication device 100. That is, when the SSID dedicated to the WAC is received, the setting application of the terminal device 200 requests a temporary connection from the communication device 100 using the SSID and a password specified in advance for the WAC. Then, the WF wireless communication section 111 of the communication device 100 receives a WAC request signal requesting a temporary connection from the terminal device 200. In response to receiving the WAC request signal, the wireless setting section 152 of the communication device 100 establishes a temporary connection with the terminal device 200 using the WF wireless communication section 111. That is, the communication device 100 and the terminal device 200 start a temporary wireless communication connection in accordance with a Wi-Fi standard. Thus, in the present embodiment, the non-DPP waiting process includes a process of waiting for a WAC request signal from the terminal device 200. In WAC, in step S25 described later, the access point information is transmitted to the communication device 100 using a temporary connection of Wi-Fi communication. Therefore, the WAC request signal can also be described as a signal by which the terminal device 200 (a device other than the access point AP) requests a wireless communication connection from the communication device 100 in order to transmit access point information to the communication device 100 via Wi-Fi communication.

Next, in step S25, the setting application of the terminal device 200 transmits access point information about the network provided by the access point AP to the communication device 100 via a communication path of the temporary connection. Accordingly, the wireless setting section 152 acquires the access point information. Here, the provided access point information includes an SSID and a password, for example. When the access point information is provided to the communication device 100, in step S26, the wireless setting section 152 disconnects the temporary connection with the terminal device 200. That is, the wireless setting section 152 ends the activation of Wi-Fi Direct (software access point). Then, in step S27, the wireless setting section 152 of the communication device 100 uses the access point information acquired from the terminal device 200 to establish a wireless connection (a wireless communication connection in accordance with the Wi-Fi standard) between the access point AP and the communication device 100 (the WF wireless communication section 111). In other words, in step S27, the communication device 100 uses the access point information to join a wireless LAN provided by the access point AP. The series of processes from step S24 to step S27 is an example of a non-DPP setting process according to WAC.

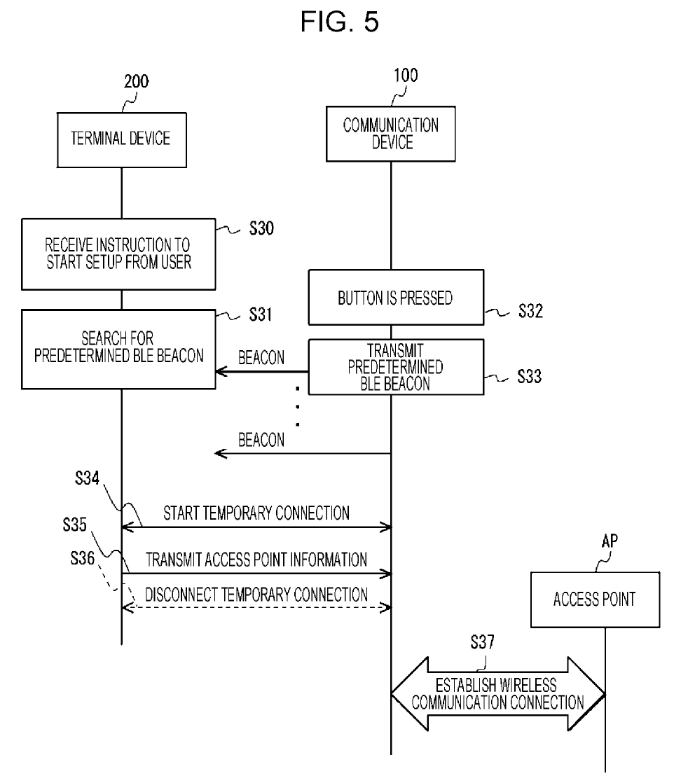

FIG. 5 is a sequence chart showing an example of a flow of wireless setting according to the fourth non-DPP method (BLE-WAC). Hereinafter, the flow of wireless setting according to the fourth non-DPP method (BLE-WAC) will be described with reference to FIG. 5. In FIG. 5, the terminal device 200 is, for example, a smartphone or a tablet terminal, but is not limited thereto.

In step S30, the user U inputs an instruction to the terminal device 200 (more specifically, the setting application of the terminal device 200) to start setup according to BLE-WAC. That is, the user U inputs an instruction to implement wireless setting according to the BLE-WAC. Accordingly, the setting application receives an instruction to start setup.

When an instruction to start setup according to BLE-WAC is received, in step S31, the setting application starts searching for (scanning) a predetermined BLE beacon for BLE-WAC using a BT wireless communication section 212, which will be described later. The BLE beacon is a beacon in accordance with the BLE standard that is transmitted from the communication device 100 in order to establish a temporary connection between the terminal device 200 and the communication device 100.

Next, in step S32, the user U operates the above-described button 131 of the communication device 100. Accordingly, the instruction receiving section 151 of the communication device 100 receives the setting start instruction, and the wireless setting section 152 starts the DPP waiting process and the non-DPP waiting process. In the present embodiment, the non-DPP waiting process includes a waiting process for the BLE-WAC. Therefore, in step S33, the wireless setting section 152 of the communication device 100 transmits a BLE beacon for a temporary connection using the BT wireless communication section 112 as a waiting process for BLE-WAC. More specifically, in the present embodiment, the wireless setting section 152 transmits a BLE beacon having a predetermined format. In this manner, since the beacon for BLE-WAC has a predetermined format, the terminal device 200 can discover the beacon for BLE-WAC. Therefore, in the sequence chart shown in FIG. 5, a setting application of the terminal device 200 discovers (receives) the BLE beacon transmitted from the communication device 100.

In step S34, the setting application of the terminal device 200 that has received the BLE beacon uses the BT wireless communication section 212 (described later) of the terminal device 200 to transmit a signal requesting a temporary connection (hereinafter also referred to as a BLE-WAC request signal) to the communication device 100. That is, when the BLE beacon is received, the setting application of the terminal device 200 requests a temporary connection via BLE communication from the communication device 100. The setting application of the terminal device 200 may display the search results for the BLE beacon (more specifically, information indicating the transmission source of the beacon specified from the received BLE beacon) on the display of the terminal device 200. In this case, the setting application may receive an input for selecting a device to be temporarily connected (that is, a device to be set as a wireless setting target), and transmit a BLE-WAC request signal in accordance with the selection. When the terminal device 200 transmits a BLE-WAC request signal requesting a temporary connection, the BT wireless communication section 112 of the communication device 100 receives the BLE-WAC request signal from the terminal device 200. In response to receiving the BLE-WAC request signal, the wireless setting section 152 of the communication device 100 establishes a temporary connection with the terminal device 200 using the BT wireless communication section 112. That is, the communication device 100 and the terminal device 200 start a temporary wireless communication connection in accordance with a BLE standard. Thus, in the present embodiment, the non-DPP waiting process includes a process of waiting for a BLE-WAC request signal from the terminal device 200. In BLE-WAC, in step S35 described later, the access point information is transmitted to the communication device 100 using a temporary connection of BLE communication. Therefore, the BLE-WAC request signal can also be described as a signal by which the terminal device 200 (a device other than the access point AP) requests a wireless communication connection from the communication device 100 in order to transmit access point information to the communication device 100 via BLE communication.

Next, in step S35, the setting application of the terminal device 200 transmits access point information about the network provided by the access point AP to the communication device 100 via a communication path of the temporary connection. Accordingly, the wireless setting section 152 acquires the access point information. Here, the provided access point information includes an SSID and a password, for example. When the setting application cannot acquire the password held by the terminal device 200, the setting application may request the user U to input the password. When the access point information is provided to the communication device 100, in step S36, the wireless setting section 152 disconnects the temporary connection with the terminal device 200. That is, the wireless setting section 152 ends the BLE communication. Then, in step S37, the wireless setting section 152 of the communication device 100 uses the access point information acquired from the terminal device 200 to establish a wireless connection (a wireless communication connection in accordance with the Wi-Fi standard) between the access point AP and the communication device 100 (the WF wireless communication section 111). In other words, in step S37, the communication device 100 uses the access point information to join a wireless LAN provided by the access point AP. The series of processes from step S34 to step S37 is an example of a non-DPP setting process according to BLE-WAC.

Next, the wireless setting method defined in the DPP will be described. DPP is a wireless setting method standardized by the Wi-Fi Alliance, and the function for performing wireless setting using the wireless setting method is called Wi-Fi Easy Connect. In the present embodiment, at least the communication device 100 is a device having Wi-Fi Easy Connect functionality. That is, the communication device 100 is a device that can execute processing according to the DPP. Further, the terminal device 200 and the access point AP may have Wi-Fi Easy Connect functionality. When not only the communication device 100 but also the terminal device 200 and the access point AP have Wi-Fi Easy Connect functionality, the communication device 100 can acquire access point information from the terminal device 200 using the wireless setting method defined in DPP and establish a wireless communication connection with the access point AP. Here, the terminal device 200 is a device that has access point information used to establish a wireless communication connection between the access point AP and the WF wireless communication section 111. The terminal device 200 may be a terminal that has already established a wireless communication connection with the access point AP. In contrast, the communication device 100 is a device that does not yet have access point information. In the wireless setting method defined in DPP, the access point information transmitted from the terminal device 200 to the communication device 100 is specifically information called a Configuration Object in DPP. The access point information transmitted from the terminal device 200 to the communication device 100 using DPP may include, for example, at least one of the SSID and the password of the network provided by the access point AP. However, this access point information may be any information required to establish a wireless communication connection with the access point AP, and may include other information instead of or in addition to the SSID or the password.

In the wireless setting method defined in DPP, access point information is transmitted from the terminal device 200 to the communication device 100 in accordance with the procedure defined in the DPP. Accordingly, the communication device 100 can establish a wireless communication connection with the access point AP. In the wireless setting method defined in DPP, the terminal device 200 operates as a configurator defined in the DPP, and the communication device 100 operates as an enrollee defined in the DPP.

In this way, when wireless setting is performed using the wireless setting method defined in DPP, the wireless setting section 152 establishes a wireless communication connection between the access point AP and the WF wireless communication section 111 in accordance with the procedure defined in DPP (Wi-Fi Easy Connect).

In DPP, the process of acquiring access point information includes three phases. Specifically, the process by which a device operating as an enrollee acquires access point information (that is, a Configuration Object) from a device operating as a configurator includes three phases: Bootstrapping, Authentication, and Configuration.

Bootstrapping is a process in which the enrollee provides predetermined information to a configurator. This predetermined information is necessary for the configurator to start communication with the enrollee in the subsequent phase, Authentication, and specifically includes the Bootstrapping Key defined in DPP. The Bootstrapping Key is the public key of the enrollee. That is, the predetermined information is information that needs to be provided to the terminal device 200 so that the terminal device 200 (configurator) can start communication with the communication device 100 according to a predetermined communication procedure for the WF wireless communication section 111 (that is, the enrollee, which is the communication device 100) to receive access point information from the terminal device 200. In other words, the predetermined information is information that the communication device 100 needs to provide to the terminal device 200 in order to enable the terminal device 200 to execute predetermined communication (communication in an Authentication phase, which will be described later). In addition, the predetermined information may include information such as a Media Access Control (MAC) address of the communication device 100. Hereinafter, the above-described predetermined information provided by the enrollee to the configurator in a Bootstrapping phase defined in the DPP will also be referred to as Bootstrapping information.

In the present embodiment, as a method of providing the predetermined information in Bootstrapping, there is a provision of a QR code (registered trademark). In the present embodiment, the provision of the QR code is realized by displaying the QR code on the UI section 130 (display), but it may also be realized by printing the QR code by the printing section 120 instead of or in addition to displaying the QR code. In contrast, communication between the terminal device 200 and the communication device 100 in the Authentication phase and a Configuration phase is performed in accordance with the Wi-Fi standard. That is, in the Authentication phase and the Configuration phase, the communication device 100 communicates with the terminal device 200 using the WF wireless communication section 111.

The Authentication is a process in which the configurator (terminal device 200) and the enrollee (communication device 100) mutually authenticate each other and generate a shared key used to encrypt the transmission of the Configuration Object. That is, in this phase, a key for encrypting access point information is generated. The terminal device 200 and the communication device 100 (wireless setting section 152) each generate a shared key based on, for example, Elliptic Curve Diffie-Hellman key exchange (ECDH). In the Authentication phase, first, the terminal device 200, which is the configurator, transmits a signal called a DPP Authentication Request to the communication device 100, which is the enrollee. This signal includes a message generated using predetermined information acquired from the communication device 100 in the Bootstrapping phase. Therefore, as described above, the predetermined information can be said to be information that needs to be provided to the terminal device 200 in order for the terminal device 200 to start communication (DPP Authentication Request) according to the predetermined communication procedure with the communication device 100. In the Authentication phase, after transmitting the DPP Authentication Request, a signal called a DPP Authentication Response is transmitted from the enrollee to the configurator. Finally, a signal called DPP Authentication Confirm is transmitted from the configurator to the enrollee.

Configuration is a process in which access point information (Configuration Object) is transmitted from the configurator to the enrollee via encrypted communication using the shared key generated in the Authentication phase. Specifically, in the Configuration phase, first, the communication device 100, which is the enrollee, transmits a signal called a DPP Configuration Request to the terminal device 200, which is the configurator. In response to this, the configurator transmits a signal called a DPP Configuration Response to the enrollee. This DPP Configuration Response includes access point information (Configuration Object).

After performing Bootstrapping, when the communication device 100 (WF wireless communication section 111) receives a signal for the Authentication phase from the terminal device 200, the wireless setting section 152 executes processes of the Authentication phase and the Configuration phase in accordance with the procedure defined in the DPP. Accordingly, the wireless setting section 152 acquires the access point information from the terminal device 200. When the access point information is acquired, the wireless setting section 152 performs a process of establishing a wireless communication connection with the access point AP using the acquired access point information.

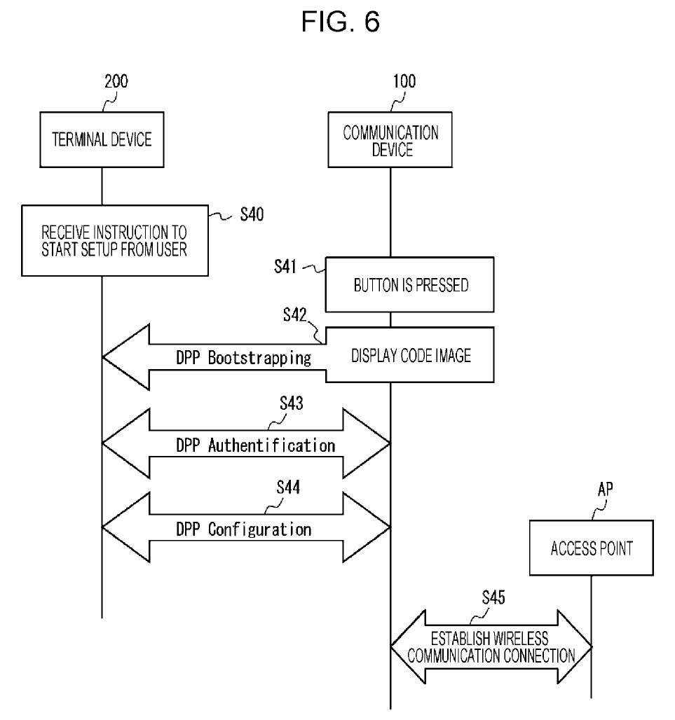

FIG. 6 is a sequence chart showing an example of a flow of wireless setting according to the wireless setting method defined in DPP. Hereinafter, the flow of wireless setting according to the wireless setting method defined in DPP will be described with reference to FIG. 6. In FIG. 6, the terminal device 200 is, for example, a smartphone or a tablet terminal, but is not limited thereto.

In step S40, the user U inputs, to the terminal device 200, an instruction to start setup according to the DPP. That is, the user U inputs an instruction to implement wireless setting according to the DPP. The start instruction from the user U may be input via application software such as the above-described setting application that operates on the terminal device 200. Accordingly, the setting assistance section 251 (described later) of the terminal device 200 receives the setup start instruction.

Next, in step S41, the user U operates the above-described button 131 of the communication device 100. Accordingly, the instruction receiving section 151 of the communication device 100 receives the setting start instruction, and the wireless setting section 152 starts the DPP waiting process and the non-DPP waiting process. Therefore, in step S42, the wireless setting section 152 of the communication device 100 performs a process of the Bootstrapping phase of DPP as the DPP waiting process, and Bootstrapping information is provided from the communication device 100 to the terminal device 200. Specifically, the wireless setting section 152 generates an image of a two-dimensional code such as a QR code in which the Bootstrapping information is encoded, and displays the image on the UI section 130 (display). Thus, in the present embodiment, the DPP waiting process includes a process of displaying, on the display of the communication device 100, a code image including information provided by the enrollee to the configurator in the Bootstrapping phase defined in the DPP. The wireless setting section 152 may cause the printing section 120 to print an image of the generated two-dimensional code. In response to this, the terminal device 200 acquires Bootstrapping information provided by the communication device 100. In addition, the wireless setting section 152 of the communication device 100 waits for a DPP Authentication Request signal from the terminal device 200.

Next, in step S43, the terminal device 200 that has acquired the Bootstrapping information transmits a DPP Authentication Request to the communication device 100 using the WF wireless communication section 211, which will be described later. When the WF wireless communication section 111 of the communication device 100 receives this, the Authentication phase starts. Thus, in the present embodiment, the DPP waiting process includes a process of waiting for a DPP Authentication Request from the terminal device 200. Thereafter, a process of the DPP Authentication phase is performed between the terminal device 200 and the communication device 100. Accordingly, a key for transmitting access point information by encrypted communication is generated.

Next, in step S44, a process of the DPP Configuration phase is performed between the terminal device 200 and the communication device 100. Accordingly, the access point information is transmitted from the terminal device 200 to the communication device 100, and the wireless setting section 152 of the communication device 100 acquires the access point information.

Thereafter, in step S45, the wireless setting section 152 of the communication device 100 uses the access point information acquired from the terminal device 200 to establish a wireless connection (a wireless communication connection in accordance with the Wi-Fi standard) between the access point AP and the communication device 100 (the WF wireless communication section 111). In other words, in step S45, the communication device 100 uses the access point information to join a wireless LAN provided by the access point AP. The series of processes from step S43 to step S45 is an example of a DPP setting process.

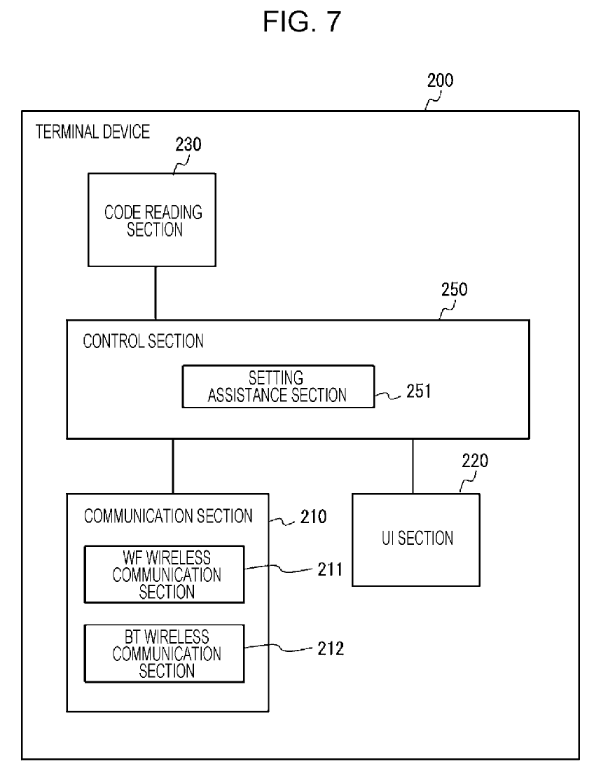

Next, the terminal device 200 will be described. The terminal device 200 is a device carried and operated by the user U, and is, for example, a smartphone, a tablet terminal, or a personal computer. FIG. 7 is a block diagram showing an example of a configuration of the terminal device 200. As shown in FIG. 7, the terminal device 200 includes a communication section 210, a UI section 220, a code reading section 230, and a control section 250.

The communication section 210 is a hardware circuit that performs wireless communication with other devices according to a predetermined communication standard, and may include software such as firmware. The communication section 210 includes a WF wireless communication section 211 and a BT wireless communication section 212.

The WF wireless communication section 211 is a circuit that performs communication in accordance with the first wireless communication standard described above. Specifically, the WF wireless communication section 211 performs wireless communication in accordance with the Wi-Fi standard.

The BT wireless communication section 212 is a circuit that performs communication in accordance with the second wireless communication standard described above. In the present embodiment, the BT wireless communication section 212 performs Bluetooth communication, which is communication in accordance with the Bluetooth standard. More specifically, in the present embodiment, the BT wireless communication section 212 performs wireless communication in accordance with the BLE standard.

The UI section 220 is a component that functions as a user interface. Specifically, the UI section 220 is a user interface device that includes an input device such as a button or a pointing device that receives input operations from the user U, and a display. The UI section 220 may be a touch panel in which an input device and a display are integrated.

The code reading section 230 is a reader that reads a code image such as a QR code. The code reading section 230 includes, for example, a camera as hardware for reading, but may also include a scanner. The code reading section 230 decodes the captured or scanned code image and reads the information represented by the code image. Therefore, the code reading section 230 can read the code image of the Bootstrapping information displayed or printed by the communication device 100.

The control section 250 controls the operation of the terminal device 200. Particularly, the control section 250 includes a setting assistance section 251 as a component for setting up wireless communication of the communication device 100. The setting assistance section 251 may be realized by, for example, a setting application installed on the terminal device 200.

When an input of an instruction to start setup from the user U is received, the setting assistance section 251 executes a process of assisting with the setting of wireless communication in the communication device 100. Specifically, the setting assistance section 251 executes either a process for wireless setting according to the third non-DPP method (WAC), a process for wireless setting according to the fourth non-DPP method (BLE-WAC), or a process for wireless setting according to the wireless setting method defined in DPP. The setting assistance section 251 may support all of these three types of wireless setting methods, or may support only one or two types of wireless setting methods. When the setting assistance section 251 supports a plurality of wireless setting methods, the setting assistance section 251 may use a wireless setting method selected by input from the user U from among the wireless setting methods.

As described above, when the setting assistance section 251 receives an input of an instruction to start setup according to the WAC, the setting assistance section 251 starts searching for (scanning) a WAC-dedicated SSID using the WF wireless communication section 211. Furthermore, when the WF wireless communication section 211 receives the WAC-dedicated SSID, the setting assistance section 251 causes the WF wireless communication section 211 to transmit a WAC request signal to the communication device 100. Then, when a temporary wireless communication connection with the communication device 100 starts, the setting assistance section 251 transmits the access point information to the communication device 100 using the WF wireless communication section 211.

Furthermore, when the setting assistance section 251 receives an input of an instruction to start setup according to BLE-WAC, the setting assistance section 251 starts searching for (scanning) BLE beacons from the communication device 100 using the BT wireless communication section 212. Furthermore, when the BT wireless communication section 212 receives a BLE beacon from the communication device 100, the setting assistance section 251 causes the BT wireless communication section 212 to transmit a BLE-WAC request signal to the communication device 100. Then, when the setting assistance section 251 starts a temporary wireless communication connection with the communication device 100, the setting assistance section 251 transmits access point information to the communication device 100 using the BT wireless communication section 212.

Furthermore, when the setting assistance section 251 receives an input of an instruction to start setup according to the DPP, the setting assistance section 251 causes the UI section 220 to display a screen requesting the user U to read a code image (Bootstrapping information) provided by the communication device 100. Then, in response to the code reading section 230 reading the code image including the Bootstrapping information, the setting assistance section 251 starts a predetermined process for transmitting access point information to the communication device 100. That is, when the terminal device 200 acquires the Bootstrapping information provided by the communication device 100, the setting assistance section 251 causes the WF wireless communication section 211 to transmit a DPP Authentication Request, and starts processing the DPP Authentication phase. Thereafter, the setting assistance section 251 executes the process of the DPP Configuration phase. Accordingly, the WF wireless communication section 211 transmits the access point information to the communication device 100 using the WF wireless communication section 211.

Next, the access point AP will be described. In the present embodiment, the access point AP constitutes a wireless LAN in accordance with the Wi-Fi standard. FIG. 8 is a block diagram showing an example of a configuration of the access point AP. As shown in FIG. 8, the access point AP includes a communication section 310, a button 320, and a control section 350.

As described above, the button 320 is a button for inputting an instruction to implement wireless settings according to WPS-PBC to the access point AP (WPS button), or a button for inputting an instruction to implement wireless settings according to AOSS to the access point AP (AOSS button). Note that the access point AP may be provided with either a WPS button or an AOSS button, or may be provided with both.

The communication section 310 is a hardware circuit that performs wireless communication with other devices according to a predetermined communication standard, and may include software such as firmware. The communication section 310 includes a WF wireless communication section 311.

The WF wireless communication section 311 is a circuit that performs communication in accordance with the first wireless communication standard described above. Specifically, the WF wireless communication section 311 performs wireless communication in accordance with the Wi-Fi standard.

The control section 350 controls the operation of the access point AP. Particularly, the control section 350 includes a wireless setting section 351 as a component for setting up wireless communication between the access point AP and the communication device 100.

When the user U operates the button 320 as a WPS button, the wireless setting section 351 executes a process for wireless setting according to the first non-DPP method (WPS-PBC). Furthermore, when the user U operates the button 320 as an AOSS button, the wireless setting section 351 executes a process for wireless setting according to the second non-DPP method (AOSS). Specifically, as described above, when the user U operates the button 320, the wireless setting section 351 causes the WF wireless communication section 311 to transmit a WPS-dedicated SSID or an AOSS-dedicated SSID for a temporary connection with the communication device 100. Furthermore, when the wireless setting section 351 receives a request for a temporary connection from the communication device 100 that has received the WPS-dedicated SSID or the AOSS-dedicated SSID, the wireless setting section 351 starts a temporary wireless communication connection with the communication device 100. Then, the wireless setting section 351 transmits the access point information to the communication device 100 using the WF wireless communication section 311.

In addition, the wireless setting section 351 executes a process of establishing a wireless communication connection with the communication device 100 based on a request from the communication device 100 that has acquired access point information using one of five wireless setting methods (the wireless setting method defined in DPP and four other types of wireless setting methods).

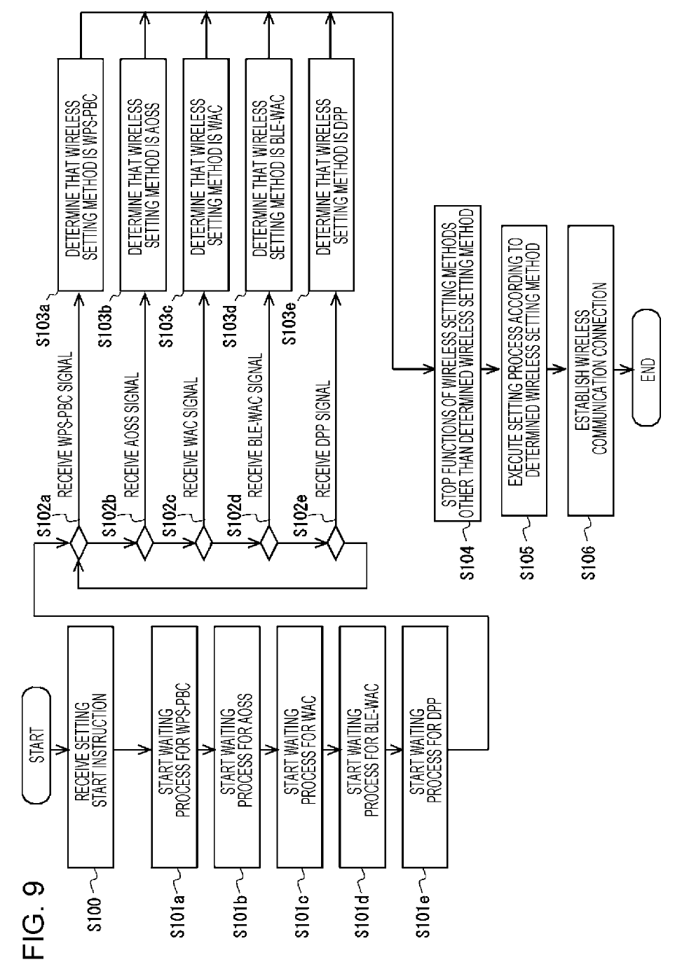

Next, a flow of operations of the communication device 100 regarding establishment of a wireless communication connection with the access point AP will be described. FIG. 9 is a flowchart showing a flow of operations of the communication device 100 according to Embodiment 1. The flow of operations of the communication device 100 will be described below with reference to FIG. 9.

In step S100, in response to the user U operating the button 131, the instruction receiving section 151 receives a setting start instruction. When the setting start instruction is received, the waiting process of steps S101a to S101e is started. In the flowchart shown in FIG. 9, steps S101a to S101e are described in this order, but these steps may be executed in any order, and are substantially executed at the same time.

In step S101a, the wireless setting section 152 starts the above-described waiting process for WPS-PBC. In step S101b, the wireless setting section 152 starts the above-described waiting process for AOSS. In step S101c, the wireless setting section 152 starts the above-described waiting process for WAC. In step S101d, the wireless setting section 152 starts the above-described waiting process for BLE-WAC. In step S101e, the wireless setting section 152 starts the above-described waiting process for DPP. Thus, in the present embodiment, in response to receiving an input of a setting start instruction, the wireless setting section 152 starts the non-DPP waiting process (steps S101a to S101d) and the DPP waiting process (step S101e). That is, a plurality of waiting processes are performed in parallel. Thereafter, the wireless setting section 152 waits for the reception of the signal to be waited.

When the communication device 100 receives a WPS-PBC signal (a signal including a WPS-dedicated SSID) (step S102a), that is, when an access point AP that is executing processing according to WPS-PBC is discovered, the wireless setting section 152 determines that the wireless setting method to be used for setting is WPS-PBC (step S103a). Thereafter, the process proceeds to step S104.

When the communication device 100 receives an AOSS signal (a signal including an AOSS-dedicated SSID) (step S102b), that is, when an access point AP that is executing processing according to AOSS is discovered, the wireless setting section 152 determines that the wireless setting method to be used for setting is AOSS (step S103b). Thereafter, the process proceeds to step S104.

When the communication device 100 receives a WAC signal (a WAC request signal) (step S102c), that is, when a temporary connection based on WAC is requested from the terminal device 200, the wireless setting section 152 determines that the wireless setting method to be used for setting is WAC (step S103c). Thereafter, the process proceeds to step S104.

When the communication device 100 receives a BLE-WAC signal (a BLE-WAC request signal) (step S102d), that is, when a temporary connection based on BLE-WAC is requested from the terminal device 200, the wireless setting section 152 determines that the wireless setting method to be used for setting is BLE-WAC (step S103d). Thereafter, the process proceeds to step S104.

When the communication device 100 receives a DPP signal (DPP Authentication Request) (step S102e), that is, when a temporary connection based on DPP is requested from the terminal device 200, the wireless setting section 152 determines that the wireless setting method to be used for setting is DPP (step S103e). Thereafter, the process proceeds to step S104.

When neither signal can be received even after a predetermined time has elapsed since the start of the DPP waiting process and non-DPP waiting process, the wireless setting section 152 may stop all waiting processes. In other words, the wireless setting section 152 may stop the DPP waiting process and the non-DPP waiting process when a predetermined time has elapsed without receiving either a signal to be waited for in the DPP waiting process or a signal to be waited for in the non-DPP waiting process. Accordingly, it is possible to prevent the processing load from continuing. In addition, when neither signal can be received even after a predetermined time has elapsed since the start of the DPP waiting process and non-DPP waiting process, the wireless setting section 152 may switch the wireless setting screen displayed on the UI section 130 to a predetermined user interface screen (UI screen) that receives operations from the user U. This predetermined UI screen is a UI screen that can receive instructions other than those for wireless settings, and specifically, for example, is a home screen. The home screen is the basic screen for all operations. Note that the wireless setting section 152 may continue some or all of the waiting processes even when a predetermined time has elapsed without receiving a signal.

When the communication device 100 receives any of the signals that are the target of waiting, in step S104, the wireless setting section 152 stops the functions of wireless setting methods other than the wireless setting method determined in any of steps S103a to S103e. That is, the wireless setting section 152 stops the waiting process for wireless setting methods other than the determined wireless setting method, and does not execute the setting process (that is, the DPP setting process or the non-DPP setting process) according to the wireless setting method. Then, the process proceeds to step S105.

In step S105, the wireless setting section 152 stops the waiting process for the wireless setting method determined in any of steps S103a to S103e, and executes the setting process according to the wireless setting method (that is, the DPP setting process or the non-DPP setting process). Then, in step S106, the wireless setting section 152 establishes a wireless communication connection with the access point AP. Accordingly, the wireless setting in the communication device 100 is completed. Upon completion of the wireless setting, the wireless setting section 152 may switch the wireless setting screen displayed on the UI section 130 to a predetermined UI screen (home screen).

When the waiting process for WPS-PBC is stopped in step S104 or step S105, specifically, the wireless setting section 152 ends the process of searching for a WPS-dedicated SSID. Furthermore, when the waiting process for AOSS is stopped, specifically, the wireless setting section 152 ends the process of searching for an AOSS-dedicated SSID. Furthermore, when the waiting process for WAC is stopped, specifically, the wireless setting section 152 ends the process of transmitting the WAC-dedicated SSID and does not respond to a WAC request signal even when the signal is received. When the waiting process for the WAC is stopped, the wireless setting section 152 ends the activation of Wi-Fi Direct (software access point), but may continue the activation. Furthermore, when the waiting process for BLE-WAC is stopped, specifically, the wireless setting section 152 ends the process of transmitting a BLE beacon and does not respond to a BLE-WAC request signal even when the signal is received. Furthermore, when the DPP waiting process is stopped, the display of the code image including the Bootstrapping information is ended. That is, in this case, the wireless setting section 152 ends the display of the code image on the UI section 130. Furthermore, when the DPP waiting process is stopped, even when it receives a DPP Authentication Request from another device, the wireless setting section 152 does not respond to the received DPP Authentication Request.

The embodiment has been described above. As described above, the communication device 100 according to the present embodiment can support a plurality of wireless setting methods, including the wireless setting method defined in the DPP. This expands the options available to users and improves usability. In addition, in the present embodiment, although a plurality of waiting processes are executed in response to a setting start instruction, upon receiving a signal, not only the waiting process for the wireless setting method corresponding to the signal but also the waiting process for the wireless setting method that does not correspond to the signal is ended. Therefore, it is possible to suppress the processing load and power consumption of the communication device 100. Particularly, it is possible to eliminate the communication load caused by the continuation of the waiting/reception process. Therefore, it is possible to suppress deterioration or the like of communication accuracy due to communication load. However, it is not necessary to end all waiting processes in response to reception of a signal, and the communication device 100 may continue some or all of the waiting processes even when it receives a signal corresponding to any wireless setting method.

### Modification Example

In the above-described embodiment, in the DPP waiting process, a process of providing a code image including Bootstrapping information is performed. However, when the communication device 100 has a Push Button Onboarding function defined in DPP, as a modification example, the following process may be performed in the DPP waiting process. That is, in this case, in the DPP waiting process, a process of transmitting a Push Button Presence Announcement may be performed instead of or in addition to the process of providing a code image. A Push Button Presence Announcement is a signal defined in DPP, which is used by the enrollee to notify the configurator that Bootstrapping information can be acquired using Push Button Onboarding.

In Push Button Onboarding, first, the communication device 100, which is the enrollee, transmits the above-described signal called Push Button Presence Announcement. That is, the wireless setting section 152 of the communication device 100 causes the WF wireless communication section 111 to transmit the signal. In response to this, the terminal device 200 (setting assistance section 251) as a configurator that has received an instruction to start setup according to DPP starts searching for a Push Button Presence Announcement signal using the WF wireless communication section 211. When the signal is discovered, the terminal device 200 (setting assistance section 251) transmits a signal called a Push Button Presence Announcement Response, as defined in DPP, using the WF wireless communication section 211. When the signal is received by the WF wireless communication section 111 of the communication device 100, the subsequent process in Push Button Onboarding starts. Thus, in the modification example, the DPP waiting process includes a process of waiting for a Push Button Presence Announcement Response from the terminal device 200. When the communication device 100 receives a DPP signal (Push Button Presence Announcement Response), that is, when a temporary connection based on DPP is requested from the terminal device 200, the wireless setting section 152 determines that the wireless setting method to be used for setting is DPP.

In the modification example, when the DPP waiting process is stopped, the transmission of the Push Button Presence Announcement is ended. That is, in this case, the wireless setting section 152 ends the transmission of the Push Button Presence Announcement using the WF wireless communication section 111. Furthermore, when the DPP waiting process is stopped, the wireless setting section 152 does not respond to the received Push Button Presence Announcement Response signal even when the signal is received from another device.

After the communication device 100, which is the enrollee, receives the Push Button Presence Announcement Response, the terminal device 200 and the communication device 100 perform Wi-Fi communication in the subsequent process in Push Button Onboarding. Accordingly, the terminal device 200 acquires the Bootstrapping information (public key) of the communication device 100. This acquisition process uses the Public Key Exchange (PKEX) technology defined in the DPP. After the Push Button Onboarding communication between the enrollee and the configurator is ended, the above-described Authentication phase and Configuration phase are processed.

According to the modification example, the communication device 100 can also support a wireless setting method using Push Button Onboarding. This makes it possible to improve usability.

### Embodiment 2

Next, Embodiment 2 will be described. The present embodiment differs from Embodiment 1 described above in that a process is added for when the DPP setting process or the non-DPP setting process fails. Hereinafter, a process different from that in Embodiment 1 will be described, and overlapping descriptions will be omitted as appropriate.

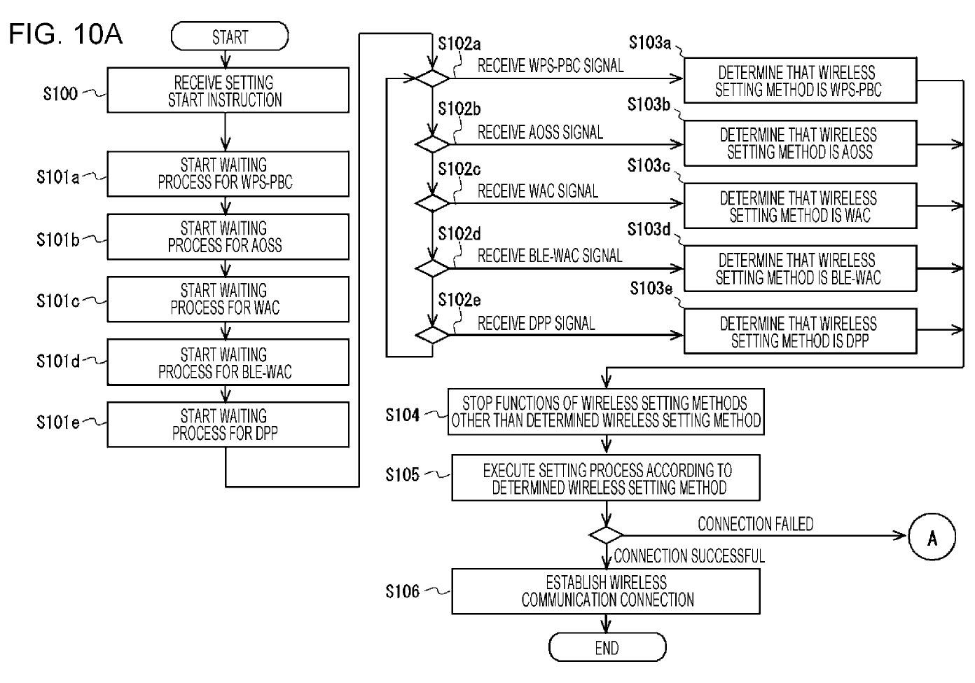

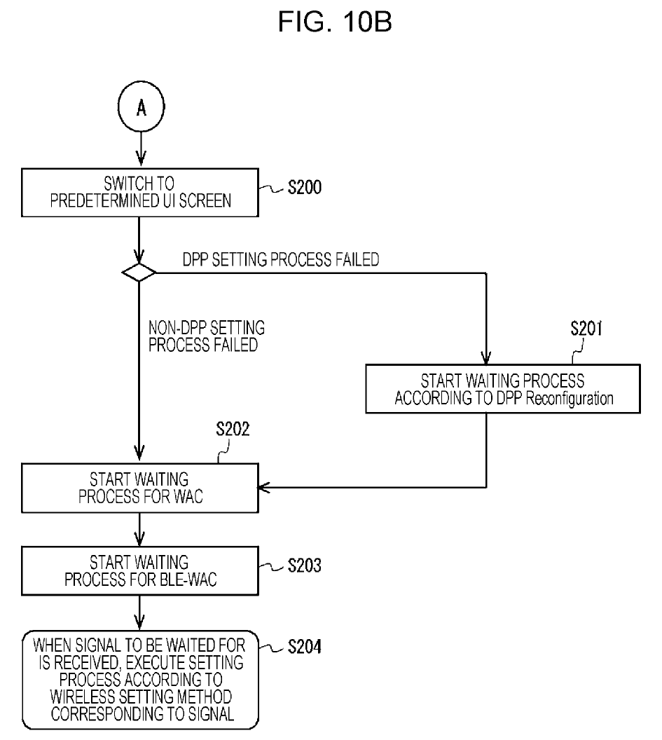

The features of Embodiment 2 will be described with reference to the drawings. FIGS. 10A and 10B are flowcharts showing a flow of operations of the communication device 100 according to Embodiment 2. Hereinafter, the features and the flow of operations of the communication device 100 according to Embodiment 2 will be described with reference to FIGS. 10A and 10B.

As shown in FIG. 10A, in Embodiment 2, the processes from step S100 to step S105 are the same as those in Embodiment 1.

In step S105, as described above, the setting process (that is, the DPP setting process or the non-DPP setting process) is executed according to the wireless setting method determined in any of steps S103a to S103e. However, the setting process according to the determined wireless setting method may fail due to some reason such as a radio wave condition. That is, the communication device 100 may fail to establish a wireless communication connection with an access point AP. Therefore, in the present embodiment, as shown in the steps described below, when the wireless setting section 152 of the communication device 100 fails to establish a wireless communication connection with the access point AP during the DPP setting process or the non-DPP setting process, the wireless setting section 152 restarts at least one of the DPP waiting process or the non-DPP waiting process.

In the present embodiment, when the setting process according to the determined wireless setting method fails, that is, when the communication device 100 fails to establish a wireless communication connection with the access point AP, the process proceeds to step S200. Furthermore, when the setting process according to the determined wireless setting method is successful, that is, when the communication device 100 succeeds in establishing a wireless communication connection with the access point AP, the process proceeds to step S106, as in Embodiment 1, and the process related to the wireless setting is ended.

When the establishment of a wireless communication connection fails, in step S200, the wireless setting section 152 of the communication device 100 switches the wireless setting screen displayed on the UI section 130 to a predetermined UI screen (home screen) that can receive operations from the user U. After step S200, the process proceeds to step S201 or step S202, and the wireless setting section 152 resumes at least one of the DPP waiting process or the non-DPP waiting process, as will be described later. In this way, when the establishment of a wireless communication connection with the access point AP fails during the DPP setting process or the non-DPP setting process, the wireless setting section 152 switches the display of the UI section 130 (display) to a predetermined user interface screen that receives operations from the user U. Then, the wireless setting section 152 restarts at least one of the DPP waiting process or the non-DPP waiting process. That is, the wireless setting section 152 switches the display of the UI section 130 to the home screen, for example, and restarts the waiting process. In this way, when the establishment of a wireless communication connection fails, the display of the wireless setting screen is ended, so that it is possible to receive any operation by the user U while resuming the waiting process. Therefore, by continuing the display of the wireless setting screen, it is possible to avoid the inconvenience that the user U is continuously hindered from operating. In the present embodiment, when establishment of a wireless communication connection fails, the display on the UI section 130 is switched from the wireless setting screen to a predetermined UI screen, but the wireless setting screen may continue to be displayed.

In the examples shown in FIGS. 10A and 10B, the process for resuming the waiting process differs depending on whether the setting process that failed in step S105 was the DPP setting process or not. When the setting process that failed in step S105 was the DPP setting process, the process proceeds to step S201. In contrast, when the setting process that failed in step S105 was the non-DPP setting process, the process proceeds to step S202.

In step S201, the wireless setting section 152 resumes the DPP waiting process. However, at this time, the wireless setting section 152 starts a waiting process according to DPP Reconfiguration. That is, when the wireless setting section 152 fails to establish a wireless communication connection with the access point AP in the DPP setting process, in step S201, the wireless setting section 152 starts a waiting process according to DPP Reconfiguration as the DPP waiting process. DPP Reconfiguration is a function defined in DPP, and is a function of omitting the process of the Bootstrapping phase and resuming the process from the Authentication phase. When the setting process that failed in step S105 was a DPP setting process, the terminal device 200 operating as a configurator should have already acquired the Bootstrapping information from the communication device 100. Therefore, in this case, it is not necessary to perform the process of the Bootstrapping phase again. That is, the DPP waiting process can be resumed without displaying the code image of the Bootstrapping information on the UI section 130. As described above, when the establishment of a wireless communication connection fails, it is preferable to switch the display of the UI section 130 to a predetermined UI screen (specifically, the home screen) so that any operation by the user U can be received. When the display of the UI section 130 is set to a predetermined UI screen, the code image of the Bootstrapping information cannot be displayed on the UI section 130. Therefore, it is difficult to perform the process of the Bootstrapping phase as the DPP waiting process. However, in the example shown in FIG. 10B, as the DPP waiting process, the waiting process according to DPP Reconfiguration is started. Therefore, the DPP waiting process can be resumed without displaying the code image.

In the waiting process according to DPP Reconfiguration, the wireless setting section 152 transmits a signal called Reconfig Announcement, which is defined in DPP, using the WF wireless communication section 111. The wireless setting section 152 repeats this signal transmission at a predetermined interval (for example, every two seconds). Upon receiving the Reconfig Announcement, the terminal device 200 (configurator) starts processing the Authentication phase. That is, the terminal device 200 transmits a DPP Authentication Request to the communication device 100. In this way, the DPP waiting process according to DPP Reconfiguration includes the process of transmitting a Reconfig Announcement and the process of waiting for a DPP Authentication Request from the terminal device 200. In addition, the DPP Authentication Request transmitted from the terminal device 200 that received the Reconfig Announcement is also referred to as a DPP Reconfig Authentication Request.

After step S201, the process proceeds to step S202. Furthermore, as described above, when the setting process that failed in step S105 was the non-DPP setting process, the process skips step S201 and proceeds to step S202.

In step S202, the wireless setting section 152 resumes the waiting process for WAC. In addition, in step S203, the wireless setting section 152 resumes the waiting process for BLE-WAC. In this way, when the establishment of a wireless communication connection fails, the wireless setting section 152 resumes the non-DPP waiting process. In addition, since the waiting process for WPS-PBC and AOSS, which searches for signals from the access point AP, places a large processing load on the communication device 100, in the example shown in FIG. 10B, only the waiting process for WAC and BLE-WAC is resumed, but the waiting process for WPS-PBC and AOSS may also be resumed. That is, as the resumption of the non-DPP waiting process, one or more of the above-described four types of waiting processes only need to be resumed.

Also, in the examples shown in FIGS. 10A and 10B, when the setting process that failed in step S105 was the non-DPP setting process, the DPP waiting process will not be resumed, but when the setting process that failed in step S105 was the non-DPP setting process, the DPP waiting process may be resumed. In this case, in order to display the code image, it is preferable that the UI section 130 continues to display the wireless setting screen. The above-described modification example can also be applied to the present embodiment. When the modification example is applied to the present embodiment, it is possible to omit displaying the code image in the Bootstrapping phase. Therefore, in this case, even when the failed setting process is the non-DPP setting process, the DPP waiting process can be resumed with the display of the UI section 130 switched to a predetermined UI screen (home screen). Also, only the DPP waiting process may be resumed, or only the non-DPP waiting process may be resumed.

After the waiting process is resumed, the process proceeds to step S204. In step S204, when a signal to be waited for is received, the wireless setting section 152 executes a setting process according to the wireless setting method corresponding to the signal.

Embodiment 2 has been described above. In the present embodiment, as described above, when the establishment of a wireless communication connection fails, the wireless setting section 152 restarts at least one of the DPP waiting process or the non-DPP waiting process. Therefore, even when wireless setting is attempted again, the process can be performed appropriately.

Although the embodiment and the modification example have been described above, the processes of the communication device 100, the terminal device 200, and the access point AP may be executed by a computer included in each device. The computer may be configured as a System on a Chip (SoC). FIG. 11 is a block diagram showing an example of a hardware configuration of a computer 900 included in the communication device 100, the terminal device 200, or the access point AP. As shown in FIG. 11, the computer 900 includes, for example, an input/output interface 901, a memory 902, and a processor 903.

The input/output interface 901 is used to communicate with any circuit or device.

The memory 902 is configured, for example, by a combination of volatile memory and non-volatile memory. The memory 902 is used to store programs executed by the processor 903, data used in various processes, and the like. The processor 903 reads a program from the memory 902 and executes the program to perform the various processes described in the above-described embodiment or modification example.

The processor 903 may be, for example, a microprocessor, a microprocessor unit (MPU), a central processing unit (CPU), or the like. The processor 903 may also include a plurality of processors.

The program includes a set of instructions (or software code) that, when loaded into a computer, causes the computer to perform one or more functions described in the embodiment. The program may be stored in a non-transitory computer-readable medium or a tangible storage medium. By way of example and not limitation, a computer-readable medium or a tangible storage medium includes a random-access memory (RAM), a read-only memory (ROM), a flash memory, a solid-state drive (SSD) or other memory technology, a CD-ROM, a digital versatile disk (DVD), a Blu-ray (registered trademark) disc or other optical disc storage, a magnetic cassette, a magnetic tape, a magnetic disk storage or other magnetic storage devices. The program may be transmitted on a transitory computer-readable medium or a communication medium. By way of example and not limitation, a transitory computer-readable medium or a communication medium includes electrical, optical, acoustic, or other forms of propagated signals.

Note that the present disclosure is not limited to the above-described embodiment, and can be modified as appropriate within the scope of the present disclosure.

Some or all of the above-described embodiments may be described as in the following supplementary notes, but are not limited to the following supplementary notes.

### Supplementary Note 1

A communication device including:

an instruction receiving section that receives an input instructing the communication device to establish a wireless communication connection with an access point; and

a wireless setting section that starts a DPP waiting process and a non-DPP waiting process in response to the reception of the input, in which

the DPP waiting process is a process of waiting for a signal from another device to establish the wireless communication connection between the communication device and the access point, the signal being a signal according to a wireless setting method defined in a Device Provisioning Protocol (DPP),

the non-DPP waiting process is a process of waiting for a signal from the other device to establish the wireless communication connection between the communication device and the access point, the signal being a signal according to a predetermined wireless setting method other than the DPP,

when the communication device receives the signal according to the wireless setting method defined in the DPP from the other device, the wireless setting section stops the DPP waiting process and the non-DPP waiting process, and executes a DPP setting process, and

the DPP setting process is a predetermined setting process for establishing the wireless communication connection with the access point according to the wireless setting method defined in the DPP.

### Supplementary Note 2

The communication device according to Supplementary Note 1, in which

when the communication device receives the signal to be waited for in the non-DPP waiting process from the other device, the wireless setting section stops the DPP waiting process and the non-DPP waiting process, and executes a non-DPP setting process, and

the non-DPP setting process is a predetermined setting process for establishing the wireless communication connection with the access point according to the predetermined wireless setting method.

Supplementary Note 3

The communication device according to Supplementary Note 1 or 2, in which

the DPP waiting process includes a process of displaying, on a display of the communication device, a code image including information provided from an enrollee to a configurator in a Bootstrapping phase defined in the DPP, and

when the DPP waiting process is stopped, the display of the code image is ended.

### Supplementary Note 4

The communication device according to any one of Supplementary Notes 1 to 3, in which

the DPP waiting process includes transmitting a Push Button Presence Announcement, which is a signal defined in the DPP, and

when the DPP waiting process is stopped, the transmission of the Push Button Presence Announcement is ended.

### Supplementary Note 5

The communication device according to any one of Supplementary Notes 1 to 4, in which

when the DPP waiting process is stopped, the wireless setting section does not respond to a DPP Authentication Request received from the other device.

### Supplementary Note 6

The communication device according to any one of Supplementary Notes 1 to 5, in which

when a predetermined time has elapsed since a start of the DPP waiting process and the non-DPP waiting process without receiving either the signal to be waited for in the DPP waiting process or the signal to be waited for in the non-DPP waiting process, the wireless setting section stops the DPP waiting process and the non-DPP waiting process.

### Supplementary Note 7

The communication device according to Supplementary Note 2, in which

when the establishment of the wireless communication connection with the access point fails during the DPP setting process or the non-DPP setting process, the wireless setting section restarts at least one of the DPP waiting process or the non-DPP waiting process.

### Supplementary Note 8

The communication device according to Supplementary Note 7, in which

when the input is received, the wireless setting section displays, on a display of the communication device, a screen according to a progress of establishing the wireless communication connection between the communication device and the access point, and

when the establishment of the wireless communication connection with the access point fails during the DPP setting process or the non-DPP setting process, the wireless setting section switches the display on the display to a predetermined user interface screen that receives an operation from a user and restarts at least one of the DPP waiting process or the non-DPP waiting process.

### Supplementary Note 9

The communication device according to Supplementary Note 7 or 8, in which

when the establishment of the wireless communication connection with the access point fails during the DPP setting process, the wireless setting section starts a waiting process according to DPP Reconfiguration as the DPP waiting process.

### Supplementary Note 10

A processing method including:

receiving, by a communication device, an input instructing the communication device to establish a wireless communication connection with an access point; and

starting, by the communication device, a DPP waiting process and a non-DPP waiting process in response to the reception of the input, in which

the DPP waiting process is a process of waiting for a signal from another device to establish the wireless communication connection between the communication device and the access point, the signal being a signal according to a wireless setting method defined in a Device Provisioning Protocol (DPP),

the non-DPP waiting process is a process of waiting for a signal from the other device to establish the wireless communication connection between the communication device and the access point, the signal being a signal according to a predetermined wireless setting method other than the DPP,

when the communication device receives the signal according to the wireless setting method defined in the DPP from the other device, the DPP waiting process and the non-DPP waiting process are stopped, and a DPP setting process is executed, and

the DPP setting process is a predetermined setting process for establishing the wireless communication connection with the access point according to the wireless setting method defined in the DPP.

### Supplementary Note 11

A non-transitory computer-readable storage medium storing a program causing a computer of a communication device to execute:

an instruction receiving step of receiving an input instructing the communication device to establish a wireless communication connection with an access point; and

a wireless setting step of starting a DPP waiting process and a non-DPP waiting process in response to the reception of the input, in which

the DPP waiting process is a process of waiting for a signal from another device to establish the wireless communication connection between the communication device and the access point, the signal being a signal according to a wireless setting method defined in a Device Provisioning Protocol (DPP),

the non-DPP waiting process is a process of waiting for a signal from the other device to establish the wireless communication connection between the communication device and the access point, the signal being a signal according to a predetermined wireless setting method other than the DPP,

in the wireless setting step, when the communication device receives the signal according to the wireless setting method defined in the DPP from the other device, the DPP waiting process and the non-DPP waiting process are stopped, and a DPP setting process is executed, and

the DPP setting process is a predetermined setting process for establishing the wireless communication connection with the access point according to the wireless setting method defined in the DPP.

What is claimed is:

1. A communication device comprising:
an instruction receiving section that receives an input instructing the communication device to establish a wireless communication connection with an access point; and
a wireless setting section that starts a DPP waiting process and a non-DPP waiting process in response to the reception of the input, wherein
the DPP waiting process is a process of waiting for a signal from another device to establish the wireless communication connection between the communication device and the access point, the signal being a signal according to a wireless setting method defined in a Device Provisioning Protocol (DPP),
the non-DPP waiting process is a process of waiting for a signal from the other device to establish the wireless communication connection between the communication device and the access point, the signal being a signal according to a predetermined wireless setting method other than the DPP,
when the communication device receives the signal according to the wireless setting method defined in the DPP from the other device, the wireless setting section stops the DPP waiting process and the non-DPP waiting process, and executes a DPP setting process, and
the DPP setting process is a predetermined setting process for establishing the wireless communication connection with the access point according to the wireless setting method defined in the DPP.

2. The communication device according to claim 1, wherein
when the communication device receives the signal to be waited for in the non-DPP waiting process from the other device, the wireless setting section stops the DPP waiting process and the non-DPP waiting process, and executes a non-DPP setting process, and
the non-DPP setting process is a predetermined setting process for establishing the wireless communication connection with the access point according to the predetermined wireless setting method.

3. The communication device according to claim 1, wherein
the DPP waiting process includes a process of displaying, on a display of the communication device, a code image including information provided from an enrollee to a configurator in a Bootstrapping phase defined in the DPP, and
when the DPP waiting process is stopped, the display of the code image is ended.

4. The communication device according to claim 1, wherein
the DPP waiting process includes transmitting a Push Button Presence Announcement, which is a signal defined in the DPP, and
when the DPP waiting process is stopped, the transmission of the Push Button Presence Announcement is ended.

5. The communication device according to claim 1, wherein
when the DPP waiting process is stopped, the wireless setting section does not respond to a DPP Authentication Request received from the other device.

6. The communication device according to claim 1, wherein
when a predetermined time has elapsed since a start of the DPP waiting process and the non-DPP waiting process without receiving either the signal to be waited for in the DPP waiting process or the signal to be waited for in the non-DPP waiting process, the wireless setting section stops the DPP waiting process and the non-DPP waiting process.

7. The communication device according to claim 2, wherein
when the establishment of the wireless communication connection with the access point fails during the DPP setting process or the non-DPP setting process, the wireless setting section restarts at least one of the DPP waiting process or the non-DPP waiting process.

8. The communication device according to claim 7, wherein
when the input is received, the wireless setting section displays, on a display of the communication device, a screen according to a progress of establishing the wireless communication connection between the communication device and the access point, and
when the establishment of the wireless communication connection with the access point fails during the DPP setting process or the non-DPP setting process, the wireless setting section switches the display on the display to a predetermined user interface screen that receives an operation from a user and restarts at least one of the DPP waiting process or the non-DPP waiting process.

9. The communication device according to claim 7, wherein
when the establishment of the wireless communication connection with the access point fails during the DPP setting process, the wireless setting section starts a waiting process according to DPP Reconfiguration as the DPP waiting process.

10. A processing method comprising:
receiving, by a communication device, an input instructing the communication device to establish a wireless communication connection with an access point; and
starting, by the communication device, a DPP waiting process and a non-DPP waiting process in response to the reception of the input, wherein
the DPP waiting process is a process of waiting for a signal from another device to establish the wireless communication connection between the communication device and the access point, the signal being a signal according to a wireless setting method defined in a Device Provisioning Protocol (DPP),
the non-DPP waiting process is a process of waiting for a signal from the other device to establish the wireless communication connection between the communication device and the access point, the signal being a signal according to a predetermined wireless setting method other than the DPP,
when the communication device receives the signal according to the wireless setting method defined in the DPP from the other device, the DPP waiting process and the non-DPP waiting process are stopped, and a DPP setting process is executed, and
the DPP setting process is a predetermined setting process for establishing the wireless communication connection with the access point according to the wireless setting method defined in the DPP.

11. A non-transitory computer-readable storage medium storing a program causing a computer of a communication device to execute:
an instruction receiving step of receiving an input instructing the communication device to establish a wireless communication connection with an access point; and
a wireless setting step of starting a DPP waiting process and a non-DPP waiting process in response to the reception of the input, wherein
the DPP waiting process is a process of waiting for a signal from another device to establish the wireless communication connection between the communication device and the access point, the signal being a signal according to a wireless setting method defined in a Device Provisioning Protocol (DPP),
the non-DPP waiting process is a process of waiting for a signal from the other device to establish the wireless communication connection between the communication device and the access point, the signal being a signal according to a predetermined wireless setting method other than the DPP,
in the wireless setting step, when the communication device receives the signal according to the wireless setting method defined in the DPP from the other device, the DPP waiting process and the non-DPP waiting process are stopped, and a DPP setting process is executed, and
the DPP setting process is a predetermined setting process for establishing the wireless communication connection with the access point according to the wireless setting method defined in the DPP.
